(19) United States
(12) Patent Application Publication
(10) Pub. No.: US 2011/0175779 A1
(43) Pub. Date: Jul. 21, 2011

(54) CONDUCTIVE STRUCTURE FOR HIGH GAIN ANTENNA AND ANTENNA

(75) Inventors: Jeongho Ju, Seoul (KR); Jae-Ick Choi, Daejeon-city (KR); Wangjoo Lee, Daejeon-city (KR); Dongho Kim, Deajeon-city (JP)

(73) Assignee: ELECTRONICS AND TELECOMMUNICATIONS RESEARCH INSTITUTE, Daejeon-city (KE)

(21) Appl. No.: 13/120,425

(22) PCT Filed: May 13, 2009
(86) PCT No.: PCT/KR2009/002529

§ 371 Date: Mar. 22, 2011

(30) Foreign Application Priority Data
Sep. 23, 2008 (KR) 10-2008-0093393

(51) Int. Cl. H01Q 19/06

(52) U.S. Cl. 343/755; 343/753

(57) ABSTRACT

Provided are a conductive structure for a high gain antenna and an antenna. A plurality of conductive patterns (512) of the conductive structure are formed on top and bottom surfaces of a dielectric substrate (511) positioned above the antenna and separated from an antenna body (500). A conductive upper structure of the antenna (510) is positioned above the antenna opposite to a ground plane (530) to which the antenna body is fed, separated from the antenna body. A conductive unit structure comprising a plurality of conductive patterns (512) formed on top and bottom surfaces of the dielectric substrate (511) is arranged in a plurality of layers. The conductive structure for a high gain antenna and the antenna can be readily produced by using low cost printed circuit board (PCB) technology, and a gain of the antenna can be increased regardless of a resonance distance between the ground plane of the antenna and the conductive structure disposed above the antenna.

### TECHNICAL FIELD

The present invention relates to a conductive structure for a high gain antenna and an antenna, and more particularly, to an antenna having a conductive structure attached to an upper portion of the antenna including a ground plane, in which a plurality of conductive patterns having particular discretionary shapes and intervals are formed on top and bottom surfaces of a dielectric substrate by using low-priced printed circuit board (PCB) technology, and the conductive structure in the antenna.

### BACKGROUND ART

In the related art, arrangement antennas in which a plurality of patch antennas are arranged above an antenna, are used in a place where a high gain radiation characteristic is needed, such as in a base station, so as to increase a gain of a base station antenna.

However, in arrangement antennas having such a shape, as the number of antennas arranged increases, an energy loss due to antenna feeding increases proportionally to the number of antennas used for feeding. As such, the efficiency of an antenna deteriorates, and the structure of the antenna becomes complicated due to fine adjustment of a feeding length, etc. to obtain a proper gain and radiation patterns.

### DISCLOSURE OF INVENTION

### Technical Problem

In addition, in order to increase the gain of the antenna, an electromagnetic bandgap (EBG) antenna in which dielectrics having a high dielectric constant are cyclically arranged above the antenna, or an antenna using a Fabry-Perot-shaped resonator in which a dielectric substrate having a metallic structure is placed on a general patch antenna, has been disclosed.

In such technology, a feeding structure is simplified, and a gain of the antenna can be increased by using single feeding, unlike in arrangement antennas. However, a resonance distance between a ground plane of an antenna and a resonator including a metallic plate disposed above the antenna must be half a wavelength of an operating frequency signal so that the height of the antenna is increased.

### Technical Solution

The present invention provides a conductive structure in which a gain of an antenna is increased regardless of a resonance distance between a ground plane of the antenna and the conductive structure disposed above the antenna, and an antenna.

### Advantageous Effects

As described below, the conductive structure according to the present invention can be readily produced by using low cost PCB technology. In addition, due to the conductive upper structure of the antenna using the conductive structure according to the present invention, efficiency, gain, and directivity of the antenna can be enhanced by using a simple source. A feeding structure is more simplified than the case where a related arrangement antenna technique is used, and loss of antenna supply power can be prevented. Furthermore, the gain of the antenna can be increased regardless of a resonance distance between the ground plane of the antenna and the conductive structure disposed above the antenna such that the spatial volume of the antenna can be reduced.

### DESCRIPTION OF DRAWINGS

The above and other features and advantages of the present invention will become more apparent by describing in detail exemplary embodiments thereof with reference to the attached drawings in which:

FIG. 1 illustrates the construction of a conductive structure according to an embodiment of the present invention;

FIG. 2 illustrates a unit cell structure of a plurality of conductive patterns of the conductive structure illustrated in FIG. 1;

FIG. 3 illustrates the construction of a two plate conductive structure in which the conductive structure illustrated in FIG. 1 is disposed as a two plate structure;

FIG. 4 is a graph showing the result of calculating a resonant frequency according to a distance between two dielectric substrates in the two plate conductive structure illustrated in FIG. 3;

FIG. 5A illustrates the construction of an antenna according to an embodiment of the present invention;

FIG. 5B is a plan view of a conductive upper structure of the antenna illustrated in FIG. 5A;

FIG. 6 is a graph showing the result of increasing a gain of an antenna according to a distance between a ground plane and a conductive upper structure of the antenna illustrated in FIG. 5A;

FIG. 7 illustrates a radiation characteristic of an antenna body taken along E-plane and H-plane in the antenna illustrated FIG. 5A;

FIG. 8 illustrates the structure of an antenna according to another embodiment of the present invention; and

FIG. 9 illustrates a radiation characteristic of an antenna body in the antenna illustrated in FIG. 8.

### BEST MODE

According to an aspect of the present invention, there is provided a conductive structure, the conductive structure including: a dielectric substrate positioned above an antenna and separated from the antenna; and a plurality of conductive patterns formed on top and bottom surfaces of the dielectric substrate.

According to another aspect of the present invention, there is provided an antenna, the antenna including: an antenna body; and a conductive upper structure positioned above an antenna opposite to a ground plane to which the antenna body is fed, separated from the antenna body, wherein, in the conductive upper structure, a conductive unit structure comprising a dielectric substrate and a plurality of conductive patterns formed on top and bottom surfaces of the dielectric substrate is arranged in a plurality of layers.

### Mode for Invention

The present invention will now be described more fully with reference to the accompanying drawings, in which exemplary embodiments of the invention are shown.

The invention may, however, be embodied in many different forms and should not be construed as being limited to the embodiments set forth herein; rather, these embodiments are provided so that this disclosure will be thorough and complete, and will fully convey the concept of the invention to those of ordinary skill in the art.

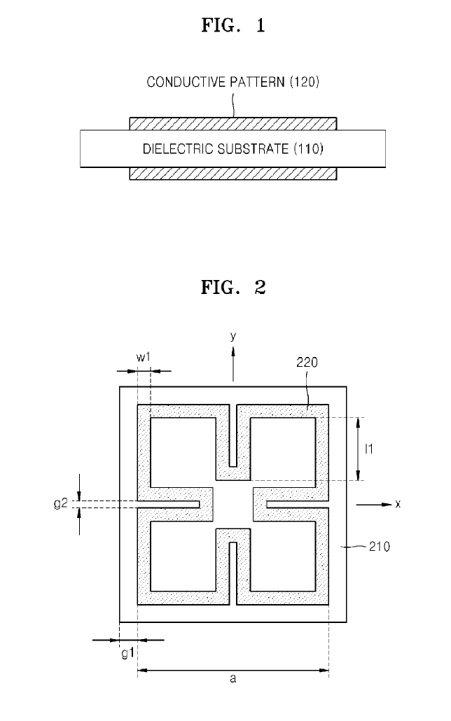

FIG. 1 illustrates the construction of a conductive structure according to an embodiment of the present invention.

Referring to FIG. 1, the conductive structure according to the current embodiment includes a dielectric substrate 110 and a plurality of conductive patterns 120. The dielectric substrate 110 is formed of a general dielectric material, and the conductive patterns 120 are etched on top and bottom surfaces of the dielectric substrate 110. The conductive structure can be readily produced by using general printed circuit board (PCB) technology.

FIG. 2 illustrates a unit cell structure of a plurality of conductive patterns of the conductive structure illustrated in FIG. 1.

The conductive patterns 120 according to the current embodiment may have a shape in which a plurality of unit patterns in which unevenness is formed symmetrically with respect to each side of a quadrangle, are arranged, as illustrated in FIG. 2. In addition, the conductive patterns 120 may have various shapes, such as rectangular or circular shapes, and various sizes according to an operating frequency and a gain of an antenna.

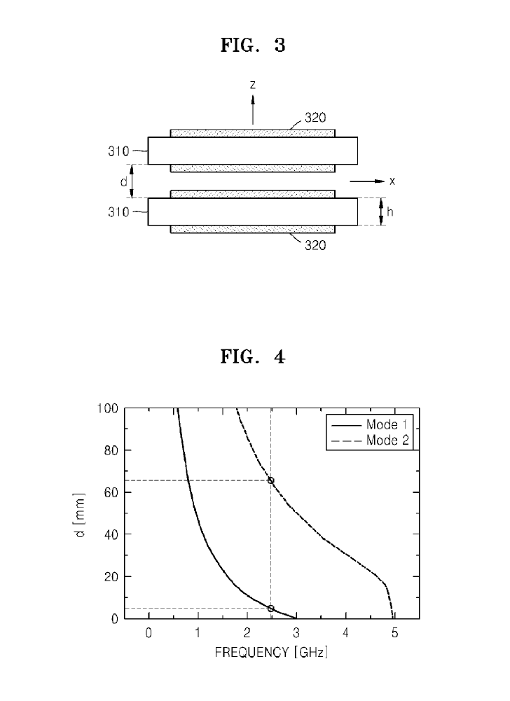

FIG. 3 illustrates the construction of a two plate conductive structure in which the conductive structure illustrated in FIG. 1 is disposed as a two plate structure.

In the current embodiment, a two plate conductive structure in which the conductive structure illustrated in FIG. 1 is arranged in two layers, is illustrated. However, the two plate conductive structure may be formed of two or more layers according to an operating frequency and a gain of the antenna.

FIG. 4 is a graph showing a result of calculating a resonant frequency according to a distance between two dielectric substrates in the two plate conductive structure illustrated in FIG. 3.

Referring to FIG. 4, in the case of an antenna that operates in a band of 2.44 GHz which is a wireless local area network (WLAN) frequency, resonance occurs at a distance d between two dielectric substrates in the two plate conductive structure, of 5 mm or 66 mm. The reason why resonance occurs at several distances is that a resonance condition is satisfied by an integer multiple of a wavelength.

Here, the resonance frequency may vary by obtaining the conductive structure by adjusting design parameters a, g, h, l, w, and d in FIGS. 2 and 3.

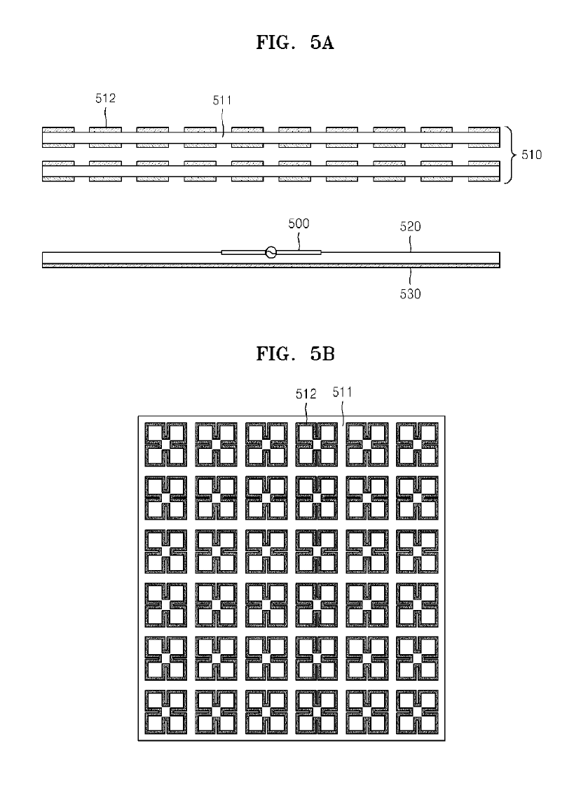

FIG. 5A illustrates the construction of an antenna according to an embodiment of the present invention, and FIG. 5B is a plan view of a conductive upper structure 510 of the antenna illustrated in FIG. 5A.

An antenna body 500 includes all antennas including a general dipole antenna and is not limited to any particular part of an antenna.

The conductive upper structure 510 is a structure which is positioned above the antenna opposite to a ground plane 530 based on the antenna body 500 and which is separated from the antenna body 500 at a predetermined distance. A conductive unit structure including a dielectric substrate 511 and a plurality of conductive patterns 512 that are formed on top and bottom surfaces of the dielectric substrate 511, are arranged in a plurality of layers.

In the current embodiment, the conductive patterns 512 are formed on top and bottom surfaces of the dielectric substrate 511 in a discretionary shape and at particular intervals and are attached to an upper portion of the antenna including the ground plane 530 so that a gain of the antenna can be increased. In addition, the conductive upper structure 510 can be readily produced by using a low-priced PCB technology and a gain of the antenna can be more efficiently increased.

A resonance minimum distance of a resonator formed of a general electrical conductor is λ/2 (where λ is a wavelength). However, in the current embodiment, a resonance distance between the ground plane 530 and the conductive upper structure 510 does not affect the gain of the antenna. In other words, the gain of the antenna can be increased proportionally to the volume of the conductive upper structure 510 regardless of a separation distance (a resonance distance) between the ground plane 530 and the conductive upper structure 410 so that the height of the antenna can be minimized and the spatial volume of the antenna can be reduced.

The antenna according to the current embodiment may be used in a place where a high gain radiation characteristic is needed.

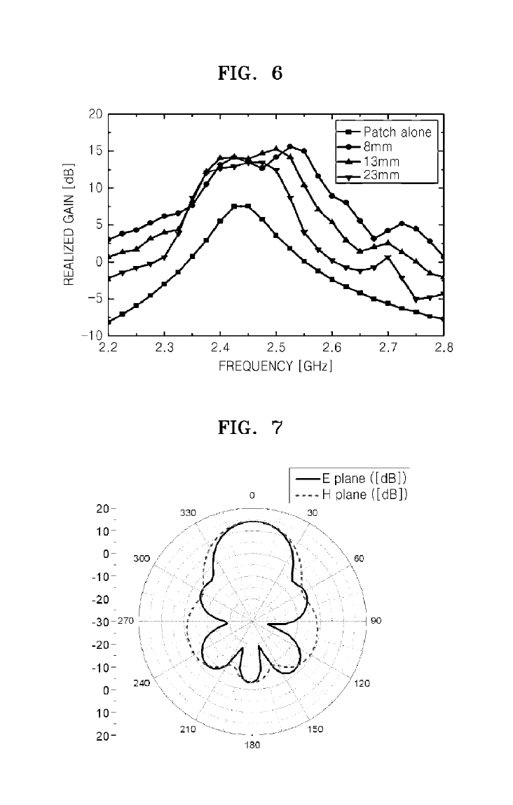

FIG. 6 is a graph showing the result of increasing a gain of an antenna according to a distance between a ground plane and a conductive upper structure of the antenna illustrated in FIG. 5A.

In the current embodiment, a rectangular patch antenna is used to supply signals. The conductive upper structure is constituted of 338 (13×13×12) conductive unit structures. Thus, in the case of an operating frequency of 2.44 GHz, the conductive upper structure has the size of 1.44λ×1.44λ.

A separation distance d between two dielectric substrates in the conductive upper structure of the antenna according to the current embodiment is 5 mm, which is the minimum resonance distance obtained in FIG. 4.

Referring to FIG. 6, there is no change in the gain of the antenna at 2.44 GHz which is an operating frequency, according to a separation distance between a ground plane of the antenna and a conductive upper structure. In addition, a gain difference of a patch antenna is 7 dB or higher depending on whether the conductive structure is positioned above the antenna body. A separation distance between the ground plane of the antenna and the conductive upper structure, i.e. 8 mm, corresponds to λ/15 of the operating frequency and becomes much smaller than λ/2 which is a relative resonance distance.

FIG. 7 illustrates a radiation characteristic of an antenna body taken along E-plane and H-plane in the antenna illustrated FIG. 5A. A measuring frequency in the current embodiment is 2.44 GHz, and beams are guided perpendicular to the antenna body.

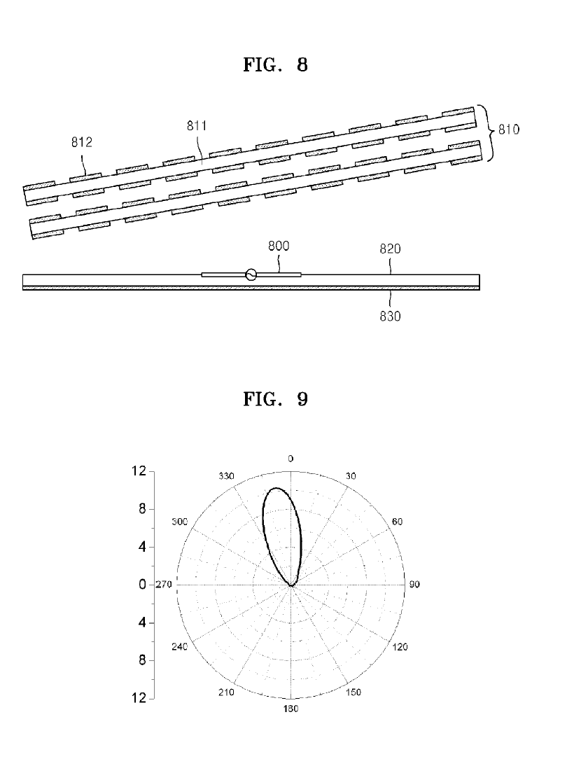

FIG. 8 illustrates the structure of an antenna according to another embodiment of the present invention. A conductive upper structure 810 according to the current embodiment is inclined with respect to an antenna body 800 at a predetermined inclination angle, unlike in the antenna illustrated in FIG. 5A. Referring to FIG. 8, when the conductive upper structure 810 is inclined with respect to the antenna body 800 at about 10 degrees, radiation patterns are inclined with respect to the antenna body 800 at 10 degrees. In other words, the direction of radiation patterns of the antenna body 800 can be adjusted according to the inclination of the conductive upper structure 810.

FIG. 9 illustrates a radiation characteristic of an antenna body in the antenna illustrated in FIG. 8. The radiation characteristic of the antenna body is guided in a direction of the inclined conductive upper structure.

As described above, the conductive structure according to the present invention can be readily produced by using low cost PCB technology. In addition, due to the conductive upper structure of the antenna using the conductive structure according to the present invention, efficiency, gain, and directivity of the antenna can be enhanced by using a simple source. A feeding structure is more simplified than the case where a related arrangement antenna technique is used, and loss of antenna supply power can be prevented. Furthermore, the gain of the antenna can be increased regardless of a resonance distance between the ground plane of the antenna and the conductive structure disposed above the antenna such that the spatial volume of the antenna can be reduced.

While this invention has been particularly shown and described with reference to exemplary embodiments thereof, it will be understood by those of ordinary skill in the art that various changes in form and details may be made therein without departing from the spirit and scope of the invention as defined by the appended claims. Therefore, the scope of the invention is defined only by the appended claims, and all differences within the scope will be construed as being included in the present invention.

1. A conductive structure comprising:
a dielectric substrate positioned above an antenna and separated from the antenna; and
a plurality of conductive patterns formed on top and bottom surfaces of the dielectric substrate.

2. The conductive structure of claim 1, wherein a conductive unit structure comprising the dielectric substrate and the conductive patterns is arranged in a plurality of layers.

3. The conductive structure of claim 1, wherein a plurality of unit patterns in which unevenness is formed symmetrically with respect to each side of a quadrangle, are arranged in the conductive patterns.

4. An antenna comprising:
an antenna body; and
a conductive upper structure positioned above an antenna opposite to a ground plane to which the antenna body is fed, separated from the antenna body,
wherein, in the conductive upper structure, a conductive unit structure comprising a dielectric substrate and a plurality of conductive patterns formed on top and bottom surfaces of the dielectric substrate is arranged in a plurality of layers.

5. The antenna of claim 4, wherein a plurality of unit patterns in which unevenness is formed symmetrically with respect to each side of a quadrangle, are arranged in the conductive patterns.

6. The antenna of claim 4, wherein, in the conductive upper structure, the conductive unit structure is arranged in two layers.

7. The antenna of claim 4, wherein a separation distance between the plurality of layers of the conductive upper structure is adjusted according to an operating frequency of the antenna body and a gain at the operating frequency.

8. The antenna of claim 4, wherein the conductive upper structure is inclined with respect to the antenna body.

9. The antenna of claim 8, wherein an inclination of the conductive upper structure is adjusted according to radiation patterns of the antenna body.
